(19) United States
(12) Patent Application Publication
(10) Pub. No.: US 2011/0200963 A1
(43) Pub. Date: Aug. 18, 2011

(54) Dental Element For Abrading Dental Composite Resin

(76) Inventor: Jeffrey T. Allen, Bloomington, IN (US)

(21) Appl. No.: 13/093,487

(22) Filed: Apr. 25, 2011

Related U.S. Application Data
(63) Continuation-in-part of application No. 12/467,592, filed on May 18, 2009.
Application No. 12/467,592 is a continuation-in-part of application No. 11/891,820, filed on Aug. 13, 2007, now abandoned.
(60) Provisional application No. 60/837,482, filed on Aug. 14, 2006.

(51) Int. Cl. A61C 3/00

(52) U.S. Cl. 433/142

(57) ABSTRACT

An abrading dental floss is characterized by dental floss formed of a circular fiber or fibrous material having a dental abrasive on the exterior portion thereof suitable for polishing, sanding and/or finishing (abrading) dental restorative material particularly dental composite resin. The dental abrading material is impregnated into or provided onto the dental floss. In one form, the dental abrading floss has an abrading section situated between lengths of non-abrading dental floss. The abrading section may be formed of an alternating pattern of non-abrasive portions and abrasive portions along a length of the floss. The abrasive portions may be of a single grit or texture of the dental abrasive or may be of different grits of the dental abrasive. In another form, the dental abrading floss has a single grit of a dental abrasive along and about its entire length. The dental abrasive may be of a single grit or different grits of the dental abrasive along its length. For different grits of the dental abrasive, it is preferred, but not necessary, that they gradually change in grit size.

### CROSS-REFERENCE TO RELATED APPLICATIONS

This patent application is a continuation-in-part of co-pending U.S. patent application Ser. No. 12/467,592 filed May 18, 2009 entitled “Dental Finishing, Sanding and/or Polishing Floss” which is a continuation-in-part of now abandoned U.S. patent application Ser. No. 11/891,820 filed Aug. 13, 2007, entitled “Dental Finishing, Sanding and/or Polishing Floss” which claims the benefit of and/or priority to U.S. provisional patent Application Ser. No. 60/837,482 filed Aug. 14, 2006, entitled “Dental Finishing and Polishing Floss”, the entire contents of all of which are specifically incorporated herein by reference.

### BACKGROUND OF THE INVENTION

1. Field of the Invention

The present invention relates to dental floss/tape used for interproximal finishing, polishing and/or sanding of a dental restorative material.

2. Background Information

Resins rather than amalgams are now predominately used for filling cavities or other dental decay and/or as a general dental restorative material. These resins possess properties that closely match natural teeth with respect to structural properties such as cohesive strength, coefficient of thermal expansion and wearability. Also, aesthetic considerations such as color stability, refractive index, plaque repellency, polishability and opacity are important factors make resins a good choice as a dental restorative material.

These composite resins have good forming characteristics so that they can be shaped to fit a cavity area or molded into place in order to repair chipped or damaged teeth. However, it is necessary to shape the repaired area by polishing or sanding the resin once the resin is cured. For instance, when resin is placed in the interproximal surface of posterior teeth such as for fixing a cavity, a matrix band is used so that the resin does not bond to the adjacent tooth. As a result, resin can overflow past the margin of the floor of the cavity preparation causing an overhang of composite resin that can create periodontal disease due to inflamed gingival or recurrent decay. Because it is optimal to create a tight, dense contact between the composite resin and the tooth in order to prevent a food trap.

One of the ways to remove a composite resin overhang is to use a size 11 scalpel. This is not always effective and can traumatize the gum tissue. Another way to remove a composite resin overhang and composite resin in general is to sand it with an abrasive. This is currently accomplished by using a strip that has a polishing material thereon. These strips however, are not ideal. If one uses a strip, the strip will crumple and therefore be unable to allow the strip to fit through the tight contact rendering the strip useless. Another manner of accomplishing abrading is by using a metal strip that has a polishing material thereon. However, if one uses a metal strip, the metal does not contour to the curvature of the tooth and thus strips the contact thereby creating a food trap (e.g. food getting caught between the teeth). Moreover, with metal strips, the metal cuts the gum tissue to shreds.

The above illustrates the problems with and shortcomings of using dental strips for abrading dental composite resin particularly in the interproximal space. Thus, while U.S. Patent Publication 2002/0081550 A1 of Karazivan discloses a tooth coating applicator in the form of a strip that may be formed of a woven fibrous material, it is still a strip (i.e. a rectangular band). As such the Karazivan strip suffers from the same disadvantages and shortcomings of all dental strips used for abrading dental composite resin, particularly in overhang situations. The same is true of U.S. Patent Publication 2005/0058963 A1 of Stockstill who discloses an interproximal reduction stripper in the form of a strip. The Stockstill strip has two distinct ends with a first end having a single abrasive side and a second end with abrasive on both sides.

It is therefore an object of the present invention to overcome the prior art deficiencies of dental restorative material polishing/sanding/finishing devices and provide a dental tool that performs abrading of dental composite resin in a hygienic, safe and easy manner.

### SUMMARY OF THE INVENTION

The present invention is a dental element for abrading dental composite resin. The dental element is formed by a length of dental floss having a circular cross section along its entire length with the dental floss incorporating an abrading material on and about the entire length of dental floss. The dental floss preferably comprises a fiber or fibrous material (collectively, fiber). The abrading material has a grit whose texture, composition and/or characteristics is sufficient to abrade dental composite resin. The fiber may be a man-made or synthetic fiber such as, but not limited to, nylon, rayon, Gore-tex® and/or the like.

The grit texture, composition and/or characteristics may be the same or may change along the length of the dental floss. Such change may be gradual or provided as sections or portions along the length.

The present dental abrading floss may have an abrading section situated between lengths or portions of the dental floss. The abrading section may be formed of a continuous portion of an abrasive or of an alternating pattern of non-abrasive portions and abrasive portions along a length of the dental floss. The abrasive/abrasive portions may be of a single grit of the dental abrasive or may be of different grits of the dental abrasive. For different grits of the dental abrasive, it is preferred, but not necessary, that they gradually change in grit size.

In one form, the dental floss has a single grit of a dental abrasive along and about its entire length.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 depicts an embodiment of a piece, strand or strip of dental finishing, polishing and/or sanding floss fashioned in accordance with the present principles;

FIG. 2 depicts another embodiment of a piece, strand or strip of dental finishing, polishing and/or sanding floss fashioned in accordance with the present principles;

FIG. 3 depicts a further embodiment of a piece, strand or strip of dental finishing, polishing and/or sanding floss in fashioned accordance with the present principles;

FIG. 4 is a sectional view of the piece of dental abrading floss taken along line 4-4 of FIG. 3;

FIG. 5 is a sectional view of the piece of dental abrading floss taken along line 5-5 of FIG. 3;

FIG. 6 is a representation of a length of the present dental abrading floss on a dental tray;

FIG. 7 is a view of a jaw of a dental patient with an area of the jaw in cutaway showing a dental work area; and

FIG. 7A is an enlargement of the circled area of FIG. 7 particularly showing the dental work area thereof illustrating dental resin filling and extending about a tooth cavity before abrasion of the dental resin with the present dental abrading floss shown ready to abrade the dental resin from the top and bottom thereof.

Like reference numerals indicate the same or similar parts throughout the several figures.

A detailed description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE PREFERRED EMBODIMENTS

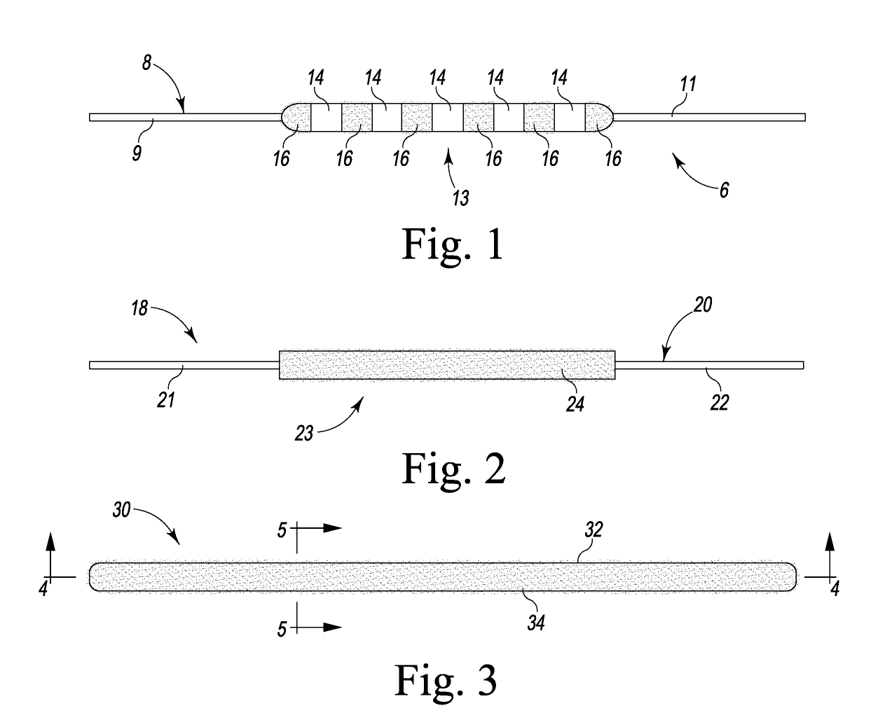

Referring to FIG. 1 there is depicted an exemplary embodiment of a dental element and particularly, there a piece or strand of dental abrading, finishing, polishing and/or sanding floss (collectively, dental abrading floss), generally designated 6, fashioned in accordance with the present principles for abrading dental composite resin. The dental abrading floss 6 is defined by a length of dental floss 8 that is made from a fiber or fibrous material (collectively, fiber) that is preferably, but not necessarily, man-made or synthetic such as, but not limited to, nylon, rayon, Gore-tex® or the like. As such, the length of dental floss 8 may be a continuous length of thread, strand, piece or the like or an individual piece thereof of any length.

The length of dental floss 8 has a circular cross section throughout its entire length and an abrasion or abrading section 13 situated between a first lateral length 9 and a second lateral length 11 each of which do not have any abrasive material thereon. It should be appreciated that the abrasion section 13 as shown in FIG. 1 is an enlargement thereof for clarity in understanding the nature of the abrading section 13 of the dental floss 8. The abrading section 13 thus is preferably the same diameter as the lateral lengths 9 and 11. Particularly, the abrading section 13 has been enlarged for detail in illustrating the alternating pattern of non-abrasive/abrading portions 14 and abrasive/abrading portions 16 along the length thereof. The abrading section 13 is thus preferably the same size as the dental floss 8.

In this embodiment, the abrasion or abrading section 13 is formed of an alternating pattern of non-abrasive/abrading portions 14 and abrasive/abrading portions 16 along the length of the abrasion or abrading section 13. The abrasion/abrading section 13 is impregnated into, coated onto or otherwise formed into/onto the dental floss. The abrading sections have an abrading material, abrader and/or grit and about/around the entire circumference and length of each abrading section. The abrasive/abrading portions 16 are formed of a gritty material such as is known in the art for finishing, polishing and/or sanding (abrading) a dental restorative material (i.e. a dental composite resin).

The abrasive/abrading portions 16, in one form, are each of the same grit or texture. Different dental abrasion/abrading flosses 6 (or abrasive/abrading sections 13 thereof) may have grit portions 16 of different grits or textures. For instance, one dental abrasion/abrading floss 6 may have “coarse” grit abrasive/abrading portions 16 for coarse finishing/polishing/sanding, one dental abrasion/abrading floss 6 may have “medium” grit abrasive/abrading portions 16 for medium finishing/polishing/sanding, and one dental abrasion/abrading floss 6 may have “fine” grit abrasive/abrading portions 16 for fine finishing/polishing/sanding. In all cases, the grit has the suitable characteristics, features and textures to abrade dental composite resin.

Alternatively, in another form of the present invention, the abrasive/abrading portions 16 are of different grits or textures along the length of the abrading/abrasion portion 13. Preferably, however, the same dental abrading/abrasion floss 6 does not have a wide variant of grits or textures along its length (e.g. “fine” to “coarse” abrasive portions 16), but may if desired. Typically, however, the abrading/abrasion portion 13 has a range of abrasive portions 16 within a same or similar grit or texture range such as a range of “fine” grits, a range of “medium” grits, or a range of “coarse” grits. For instance, a first abrasive portion 16 (as arbitrarily viewed starting from the left side of FIG. 1) may have a “super, super fine” grit, then a “super fine” grit, and so forth within a range of “fine” grits.

Referring now to FIG. 2 there is depicted another embodiment of the present dental abrading floss fashioned in accordance with the principles of the present invention. Particularly, there is depicted a piece of dental polishing and/or sanding floss, generally designated 18, fashioned in accordance with the present principles. The dental abrasion floss 18 is again defined by a length of dental floss 20 of a circular cross section throughout its entire length and that is made from a fiber or fibrous material (collectively, fiber) that is preferably, but not necessarily, man-made or synthetic such as, but not limited to, nylon, rayon, Gore-tex® or the like. As such, the length of dental floss 8 may be a continuous thread/strand/piece/strip and/or the like (collectively piece), or an individual piece of any length.

In accordance with the principles of the present invention, the length of floss 20 has a finishing/polishing/sanding (abrading or abrasion) section 23 connected between non-abrading portions 21 and 22 of the length of dental floss 20. The abrading/abrasion section 23 is formed of a flat plastic strip having a dental finishing/polishing/sanding (abrasion or abrading) material 24 impregnated into or coated onto the abrading/abrading section 23. The dental abrading material 24 is a gritty or textured material such as is known in the art for finishing, polishing and/or sanding (abrading) a dental restorative material (e.g. a dental resin). The dental polishing/sanding material 24 is of a single grit or texture such as “fine”, “medium”, “coarse” or the like. The flat plastic strip 23 may be an alternating pattern as in the embodiment of FIG. 1.

FIG. 2 also represents an embodiment of an abrading dental floss such as is described in connection with FIG. 1 wherein the abrading section 23 is not a plastic strip but is of a fiber dental floss. The abrading section 23 is of a gritty or textured material such as is known in the art for finishing, polishing and/or sanding (abrading) a dental restorative material (e.g. a dental resin). The dental polishing/sanding material 24 is of a single grit or texture such as “fine”, “medium”, “coarse” or the like. In this embodiment, it should be appreciated, that the abrasion section 23 is shown in FIG. 2 as an enlarged portion—this is for clarity to understand the nature of the abrading section 23 of the dental floss, but is not necessarily so. Particularly, the abrading/abrasion section 23 has been enlarged for detail in illustrating the continuous nature of the abrading portion 23 along the length thereof. The abrading/abrasion section 23 is thus preferably the same size as the dental floss. Therefore, reference to FIG. 3 is made to show what the embodiment of FIG. 2 looks like without such enlargement of the abrading section 23.

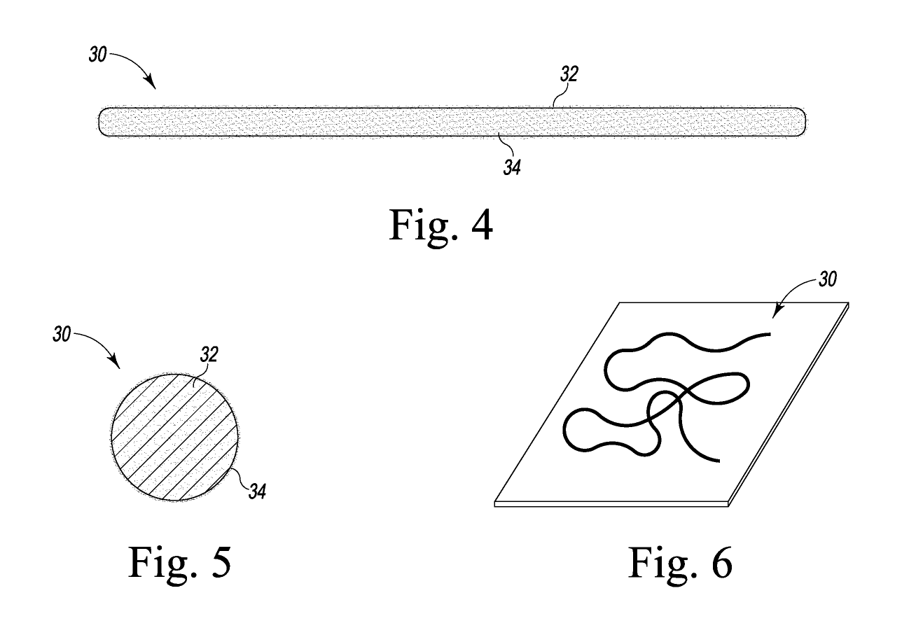

Referring to FIG. 3 there is depicted another embodiment of the present dental abrasion floss fashioned in accordance with the principles of the present invention. Particularly, there is depicted a piece or length of dental abrading floss, generally designated 30. The dental abrading floss 30 is defined by a length of dental floss 32 having a circular cross section along its entire length (see particularly FIGS. 4 and 5) and which is made from a fiber or fibrous material (collectively, fiber) that is preferably, but not necessarily, man-made or synthetic such as, but not limited to, nylon, rayon, Gore-tex® or the like. As such, the length of dental floss 32 may be a continuous thread, strand, piece, length and/or the like (collectively length), or an individual piece of any length such as depicted in FIG. 6 wherein a long length of the present dental abrading floss 30 is shown piled on a tray.

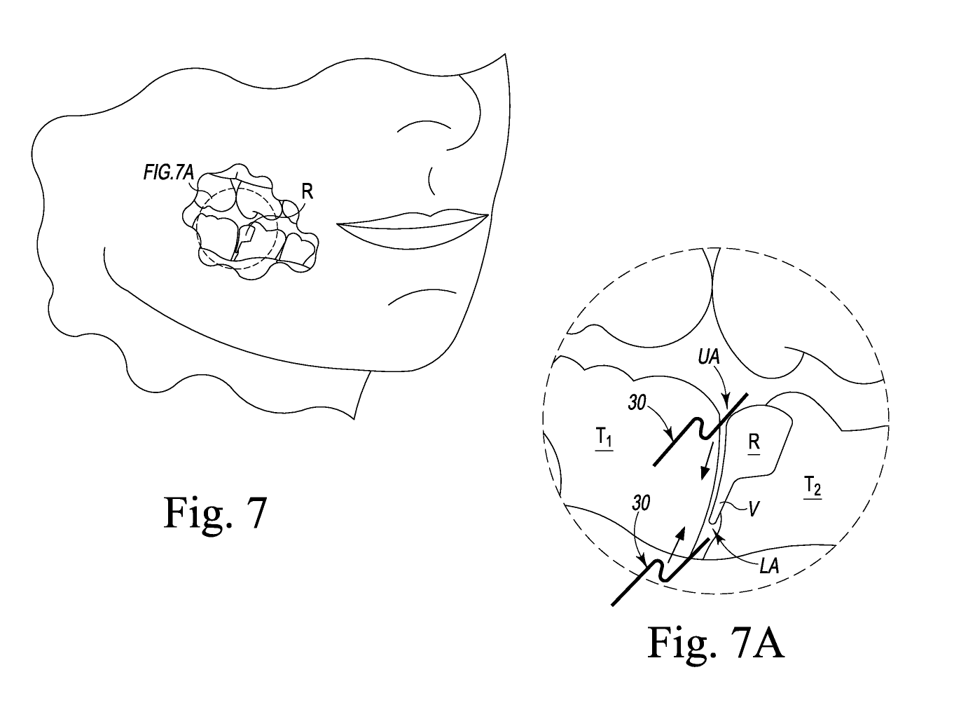

In this embodiment, the length of floss 32 is entirely impregnated, coated or otherwise formed with a dental abrasion, abrader or abrading material (abrader) 34 thereon and around the circumference of the entire length of floss 32. The abrader 34 is a grit, or gritty textured material such as is known in the art for abrading a dental restorative material (i.e. a dental composite resin). The dental abrasion or abrading material 34 is preferably, but not necessarily of a single grit such as fine, medium, coarse or therebetween. The length of floss 32 may also have a change in grit along its length such as described above. In all cases, the length of floss 32 has the characteristics of dental floss wherein it is strong, resilient and flexible in order to allow the dental abrading floss to get into the areas between teeth (interproximal) and to places around a tooth wherein it is traditionally difficult to do with strips or the like. This is because a circular rather than a flat element (i.e. a strip) is used. To illustrate, reference is made to FIGS. 7 and 7A.

In FIG. 7 there is depicted a partial view of a lower portion of a person's face particularly showing the jaw thereof. A segment of the person's jaw is shown in cutaway view wherein several teeth are visible and a patch, implant or filling of a dental composite resin (restorative material) R is seen. Referring to FIG. 7A, the filling of dental composite resin R is seen in greater detail with respect to its host tooth T₂ and an adjacent tooth T₁ of which an overhang V that extends downward from the main body of the filling R can be seen. It is thus necessary to remove the overhang V. The overhang V is not easily reached since it is in the interproximal space between tooth T₁ and tooth T₂. It can be discerned that a strip would not be easily inserted into the aforementioned interproximal space. How the present dental abrading floss 30 can accomplish this task.

As illustrated in FIG. 7A a piece or length of abrading floss 30 may be inserted into the interproximal space between tooth T₁ and tooth T₂ from above the teeth via an upper area UA or from below and between the teeth via a lower area LA. When coming from above, the floss must be forced down through and between the teeth T₁, T₂ to reach the overhang V. Since the floss 30 has the characteristics described herein, this can be easily accomplished. When the abrading floss 30 comes from below, it must be inserted through the teeth T₁, T₂ near the gum line. Since the present abrading floss 30 has the characteristics described herein, this can be easily accomplished.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. A dental element for abrading dental composite resin applied to a tooth, the dental element comprising:
a length of fibrous dental floss having a circular cross section along its entire length; and
an abrasion material suitable for abrading dental composite resin provided entirely along and about the length of fibrous dental floss.

2. The dental element of claim 1, wherein the length of fibrous dental floss is formed from a synthetic fiber.

3. The dental element of claim 2, wherein the synthetic fiber comprises nylon.

4. The dental element of claim 1, wherein the abrasion material has a particular grit size that comprises one of a fine texture, a medium texture and a coarse texture.

5. The dental element of claim 1, wherein the abrasion material has a grit size that increases along the length of fibrous dental floss.

6. The dental element of claim 1, wherein the length of fibrous dental floss has an alternating pattern of abrasion material then no abrasion material.

7. A dental element for abrading dental composite resin restorative material applied to a tooth, the dental element comprising:
a length of fibrous dental floss having a circular cross section along its entire length; and
an abrader of a particular grit size suitable to abrade dental composite resin provided about an entire outside surface of the fibrous dental floss.

8. The dental element of claim 7, wherein the fibrous dental floss comprises a synthetic fiber.

9. The dental element of claim 8, wherein the synthetic fiber comprises nylon.

10. The dental element of claim 7, wherein the grit size of the abrader comprises one of a fine texture, a medium texture and a coarse texture.

11. The dental element of claim 7, wherein the grit size of the abrader increases along the length of the fibrous dental floss.

12. A dental element for abrading dental composite resin applied to a tooth, the dental element comprising:
a piece of nylon dental floss having a circular cross section along its entire length; and
an abrader formed on and about the entire length of the piece of dental floss, the abrader having a texture whose grit size and composition abrades dental composite resin upon repeated rubbing of the abrader against the dental composite resin.

13. The dental element of claim 12, wherein the grit size of the abrader comprises one of a fine, medium and coarse.

14. The dental element of claim 12, wherein the grit size of the abrader increases along the piece of nylon dental floss.
